(19) United States
(12) Patent Application Publication
(10) Pub. No.: US 2004/0201467 A1
(43) Pub. Date: Oct. 14, 2004

(54) Early warning system for car tire's temperature and pressure

(75) Inventor: Chun-Chung Kuo, Taipei (TW)

Correspondence Address: BACON & THOMAS, PLLC, 625 SLATERS LANE, FOURTH FLOOR, ALEXANDRIA, VA, 22314

(73) Assignee: VARIFORM INDUSTRIAL LTD., Taipei (TW)

(21) Appl. No.: 10/412,282

(22) Filed: Apr. 14, 2003

(51) Int. Cl. B60C 23/00

(52) U.S. Cl. 340/445

(57) ABSTRACT

This invention is related to an early warning system for car tires' temperature and pressure, wherein a processor for alarm receiving mounted in said early warning system is mainly connected to a car's rear-view mirror, wherein said alarm information may be acknowledged by the driver through said glass mirror surface, wherein alarm detection information of a plurality of detecting functions, such as pressure detecting, temperature detecting, weak current detecting, may be simply and easily coupled to each tire rim of said car for basis of variations detected, and wherein data as information timely collected are sent to the processor for alarm receiving by way of wireless transmission in order to compare, and then after comparison may be shown on the rear-view mirror for the driver to see instantly when an alarm condition happens, and may function as alarm information, for achievement of the preferable invention with skilful design and availability.

### FIELD OF THE INVENTION

This invention is related to an early warning system for car tires' temperature and pressure, and especially to a system coupled to a car's rear-view mirror to have alarm information shown through the glass mirror surface for achievement of the alarm function, and further said system may provide a plurality of detection functions, such as tire pressure detection, temperature detection, weak current detection and so on, and may send said information by way of wireless transmission so that the entire device may be simply and easily installed and operated, and does not fall during driving resulting in danger, which will make the driver safer during driving.

### BACKGROUND OF THE INVENTION

In accordance with a car serving as a vehicle commonly used in modern life as a vehicle featured with fast, smooth, and easy driving and also as a vehicle convenient and mobile to people, servicing and maintenance for cars and motorcycles are more important increasingly. Especially, tire servicing and maintenance are one of the more essential affairs; many drivers always neglect a check on the tire pressure because of their different judgment or erroneous judgment by individual experience so as to neglect the inspection of the tire pressure; therefore, once the tire pressure is not enough, the drivers may not promptly be aware of said situation to improve so that the tire rim or the other related components and assemblies will be made affected and then damaged, or even that an accident happens so as to endanger their lives, fortune, and security.

So far, various pressure detection devices, such as the use of a spring or air pressure as a basis to detect the tire pressure, related to the car tire are provided, hence said pressure detection device is installed in the center of tire axle or in the position of tire port or tire air tap, and externally connected to a receiver and a display using line connection in order to show the tire pressure value measured by the pressure detection device for safe driving by way of immediate knowledge of the tire pressure measured.

In fact, the traffic accidents having happened due to the tire pressure on early days resulted mainly from no drivers' instant knowledge of the insufficient tire pressure, but from their misjudgments by driving experience, so the current tire pressure detection device has been able to at any time detect the tire pressure variation at the case of driving so as to greatly decrease and avoid the accident; it is known that the display of the conventional tire pressure detection device disclosed before is externally connected and fixed to the inside of a car; however, the cars in general is not beforehand provided with a space for said receiver or display, and most of the drivers do not securely fix it in place inside the car because of the aesthetic inside the car so that when the running car turns a corner and vibrates, said receiver or display is so easily made dropped as to endanger the driving security.

For the above-mentioned reason, thinking that the conventional pressure detection device is not easily installed and not provided with a constant space for installation of the receiver or display, this inventor further gives the utmost attention to the test and research, and in a perseverant spirit of invention finally creates a brand-new tire pressure device with warning system for a multitude of drivers' convenient use.

### SUMMARY OF THE INVENTION

This invention is mainly to provide a car-use tire temperature and pressure early warning system connected to and hidden in the car's rear-view mirror for the purpose of accurate use, secure and easy installation, easy operation, and no danger caused from the processor for alarm receiving dropped when the car runs.

To achieve the former objective, a brand-new car-use tire temperature and pressure early warning system is invented mainly to connect the processor for alarm receiving in said early warning system to the rear-view mirror of the car while the alarm information through the glass mirror surface may clearly show the driver and the transmitter providing various detecting functions such as pressure detection, temperature detection, weak current detection and the like as a alarm and detector is simply and easily coupled to each tire rim of the car for basis of the variations detected; also, each data as information periodically collected is sent, through wireless transmission, to the processor for alarm receiving to compare, and then said information may be immediately shown on the rear-view mirror for the driver to see in a minute, which will achieve an objective of the early warning.

Sincerely hoping that all you reviewers may further understand the characteristics and technical descriptions of this invention, we attach the following detailed descriptions and accompanying drawings related to this invention for your reference; however, the accompanying drawings are provided only for reference and description but not used to confine this invention.

### BRIEF DESCRIPTION OF THE DRAWINGS

FIG. 1 shows a 3-D decomposition chart according to this invention.

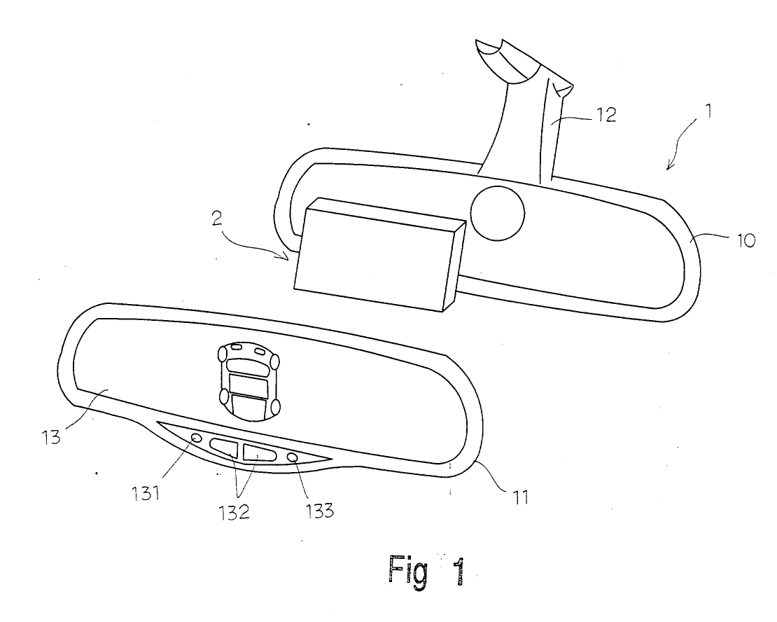

FIG. 2 shows a circuit block diagram of a processor for alarm receiving according to this invention.

FIG. 3 shows a circuit block diagram of a sensor host according to this invention.

FIG. 4 is a schematic diagram for the practical installation of the sensor host according to this invention.

FIG. 5 shows an appearance of a remote controller according to this invention.

FIG. 6 is an appearance drawing with three dimensions according to this invention.

FIG. 7 is a schematic diagram for a preferred exemplary state according to this invention.

### DETAILED DESCRIPTION OF THE INVENTION

This invention is related to a tire temperature and pressure early warning system. Refer to the accompanying drawings for the configuration and installation of said system, shown as follows:

Three main parts structured in this early warning system 2: transmitter for alarm and detection 30, processor for alarm receiving 20, system remote control setting host 40.

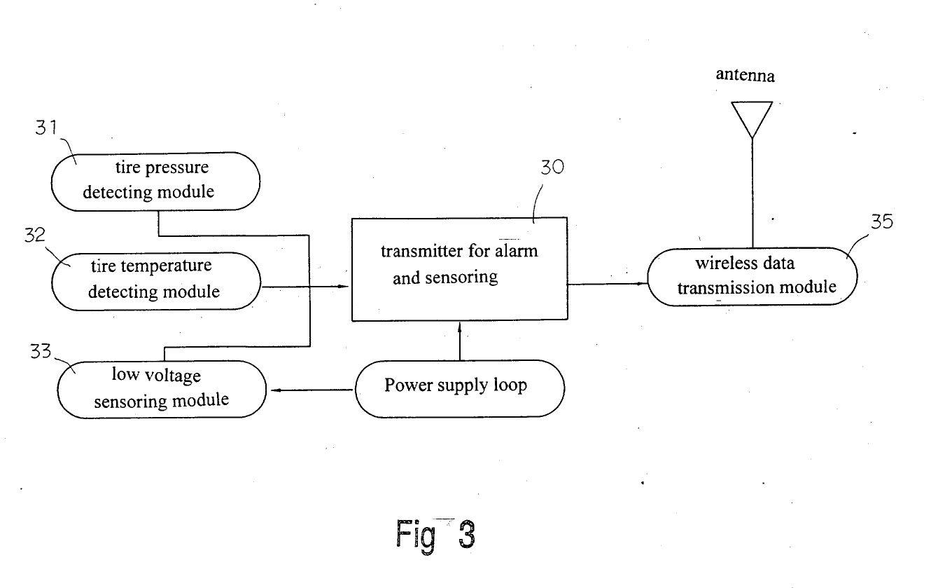

As shown in FIG. 3, the concrete structures and corresponding functions of the transmitter for alarm and detection 30 are:

1. Tire pressure detecting module 31, in order to get the data related to the pressure inside the tire,

2. Tire temperature detecting module 32, in order to get the data related to the temperature inside the tire,

3. Low voltage detecting module 33, in order to gather the data related to the current condition of the battery, and

4. Wireless data transmission module 35, in order to unidirectionally transmit the data at 315 MHz/433 MHz to the processor for alarm receiving 20.

Each of said data collected from said transmitter for alarm and detection 30 is updated and then sent per 10 seconds.

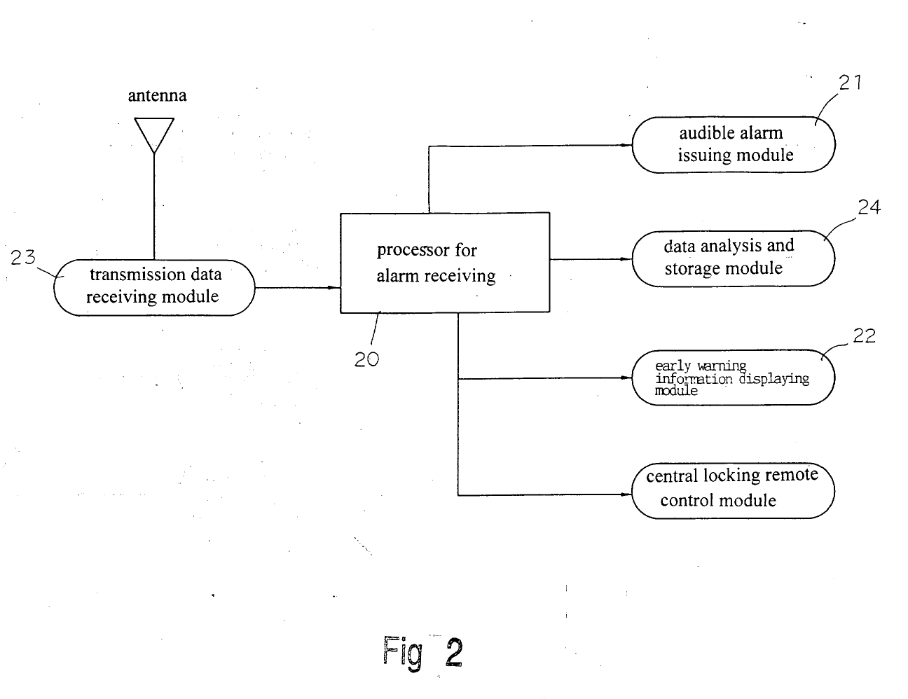

As shown in FIG. 2, the processor for alarm receiving 20 is comprised of wireless transmission data receiving module 23, data analysis and storage module 24, audible alarm issuing module 21, and early warning information displaying module 22.

The wireless transmission data receiving module 23 promptly analyzes and then processes all the data collected and next sent by the transmitter for alarm and detection 30; if one or some of the data collected goes beyond the range of the security value preset, the data analysis and storage module 24 at once saves the alarm data and have the audible alarm issuing module 21 off hand sound for early warning, while the early warning information displaying module 22 also instantly hands over the insecurity data to a displaying terminal and tells the alarm type for achievement of the early warning and recording functions.

Under a condition of no alarm issuing, the processor for alarm receiving 20 may provide an inquiry service for the state of the current tire temperature and pressure to take precautions against a calamity.

Further, the processor for alarm receiving 20 may keep at most 40 various early warning values of irregular conditions for next data interpretation.

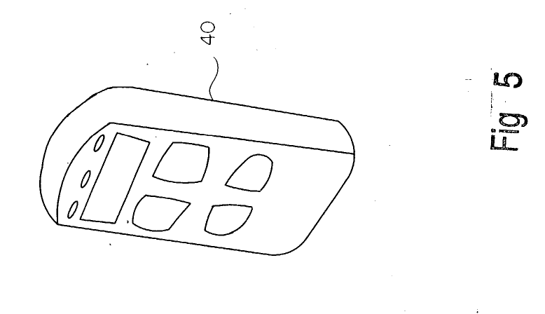

As shown in FIG. 5, the system remote control setting host 40 runs with this early warning system 2 to remotely control each of the parameters for setting. Currently, a general Central Door Locking function is integrated for users to conveniently operate.

The transmitter for alarm and detection 30 and the processor for alarm receiving 20 both in this system are respectively described in the following for the installation procedures:

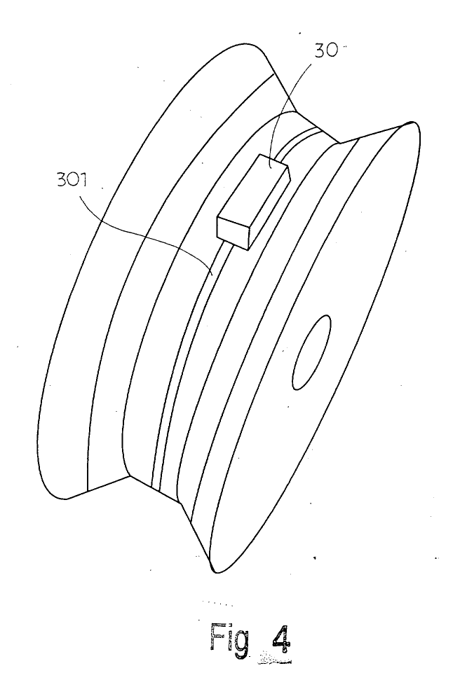

1. The embodiment of the installation procedures of the transmitter for alarm and detection 30 is given, wherein: a fixture function of a binding strap 301 with one-way claws, as shown in FIG. 4, is used to have the transmitter for alarm and detection 30 easily and fixedly mounted on the tire rim, and when the parameters of this early warning system 2 are set, the only one 64-bit ID code will be provided in the processor for alarm receiving 20 to correspond to the transmitter for alarm and detection 30 attached in each tire, thereby being not under consideration for correspondence when a practical assembly for this early warning system 2 is implemented.

2. For installation, the processor for alarm receiving 20 is connected to the car-use rear-view mirror and designed corresponding to its structure, and the embodiment is given, in which

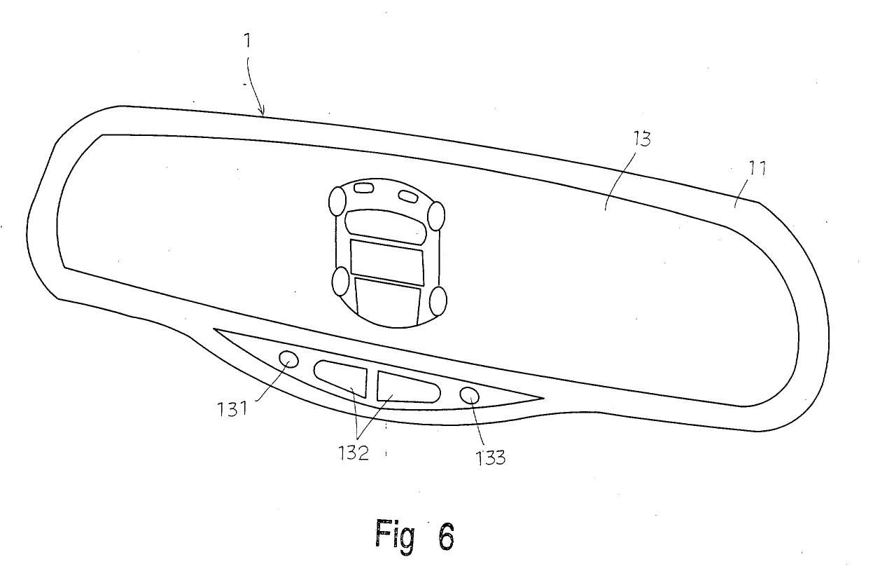

a general car-use rear-view mirror 1 is structured with a back cover 10 and a front cover 11 both coupled. A central pivot at an external side of said back cover is fixed with a fixture 12 movable, and a glass mirror surface 13 is embedded between said front cover 11 and back cover 10, in which said glass mirror surface 13 is processed with anti-glare and perspective techniques; also, a state displaying device (not shown) adheres to the back side of glass mirror surface 13 to provide a high-quality display at the time of early warning conditions resulting and to provide the regular rear-view mirror use for observation at the time of no early warning conditions happening after the processor for alarm receiving 20 is embedded. The bottom of the front side of rear-view mirror is provided with an alert sound hole 131, a control button 132, and a power-indicating lamp 133. The processor for alarm receiving 20 is embedded between the back cover 10 and the front cover 11. As shown in FIG. 6, this early warning system 2 is securely installed and easily operated using said manners.

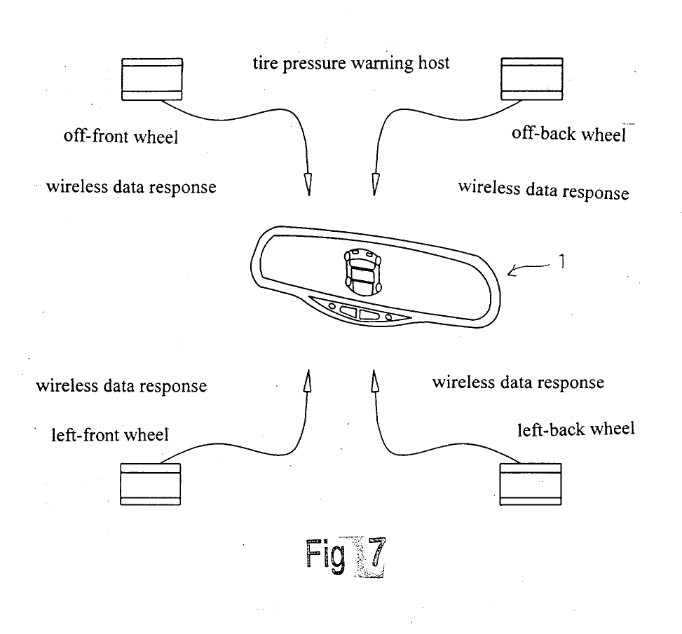

As shown in FIG. 7, after this early warning system 2 is practically implemented, the user may at any time be informed of the states of the car's tire dynamic pressure (over or under), temperature (over), increasing pressure down (flat tire), and weak current or failure of the battery during driving using the glass mirror surface 13 structured in said rear-view mirror 1 to see through the display of the processor for alarm receiving 20, and then may timely cope with said problems against accidents.

From the descriptions mentioned above, it is easily found that this invention is mainly used to connect the early warning system for car tires' temperature and pressure and hidden it in the rear-view mirror, and to simply and easily couple, with the tire rim, the transmitter for alarm and detecting with multi-functions such as pressure detection, temperature detecting, weak current detecting and so on for a basis of the variations detected, in which each data as information timely collected is sent to the processor for alarm receiving by way of wireless transmission in order to compare, and then said data after compared, when an alarm condition appears, may be shown on the rear-view mirror for the driver to instantly see for achievement of the alarm function; further, it is quite novel and creative that this invention combine the processor for alarm receiving with the rear-view mirror structure as a 2-in-1 practice, and that no ganger results from the processor for alarm receiving fallen during driving, thereby highly securing the driver against a danger.

To sum up, this invention “early warning system for car tires' temperature and pressure” may certainly reach precise, facile, and safe efficiency of pressure, temperature, current and the like, and may be remarkably be improved for time saving and labor saving for installation; also, it is reasonable for us to apply for an innovation patent because of the structure not published or disclosed, so we apply for it according to law and earnestly request you to give the patent right.

The foregoing descriptions may only be the preferable embodiments implemented for this invention, and is not to be construed as a limitation. It is therefore intended by the appended claims to cover any and all such applications, modifications, and embodiments within the scope of the present invention.

What is claimed is:

1. A tire pressure warning system device comprising:
a rear-view mirror structure made of a front cover and a back cover both work with each other, a processor for alarm receiving installed therein;
an early warning system including said processor for alarm receiving and some transmitters for alarm and detection, wherein said processor for alarm receiving is provided in a rear-view mirror and said transmitters for alarm and detection are provided on a tire rim;
wherein data as information related to tire pressure and temperature is collected by each transmitter for alarm and detection and sent back to said processor for alarm receiving for judgment and analysis on said data received; also, an alarm sounds beyond each default range, and said warning information may appear via said rear-view mirror and simultaneously sounds at the time of a situation reaching said alert function required.

2. The tire pressure warning system device of claim 1, wherein said front cover is embedded with a glass mirror surface processed with anti-glare and perspective techniques, and a state displaying device is installed at a back side of said glass mirror surface.

3. The tire pressure warning system device of claim 1, wherein said processor for alarm receiving is designed, as a circuit structure, with a wireless transmission data receiving module, a data analysis and storage module, an audible alarm issuing module, and an early warning information displaying module, these are the units in series connected together in order to receive collected detection data sent back by said transmitter for alarm and detection through wireless transmission and then to analyze, determine and save said data.

4. The tire pressure warning system device of claim 1, wherein said transmitter for alarm and detection is designed, as a circuit structure, with a tire pressure detection module, a tire temperature detection module, a low voltage detection module, and a wireless data transmission module, these are the units in series connected together.

5. The tire pressure warning system device of claim 1 or 4, wherein a 64-bit ID code is provided in said processor for alarm receiving, and said 64-bit ID code may optionally work with said processor for alarm receiving and may be controlled by programs of said processor for achievement of elastic correspondence and detection to said tires.

6. The tire pressure warning system device of claim 1 or 3, wherein said processor for alarm receiving may reserve various early warning values of irregular conditions for next determination of data.

7. The tire pressure warning system device of claim 1, wherein a system remote control setting host for remote control is additionally provided in said processor for alarm receiving to couple with a central door locking function.
